(19) United States
(12) Patent Application Publication
(10) Pub. No.: US 2010/0305273 A1
(43) Pub. Date: Dec. 2, 2010

(54) REACTION RESIN COMPRISING CORE-SHELL PARTICLES AND METHOD FOR THE PRODUCTION THEREOF AND THE USE THEREOF

(75) Inventors: Oliver Schaefer, Burghausen (DE); Helmut Oswaldbauer, Stubenberg (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/599,193

(22) PCT Filed: May 19, 2008
(86) PCT No.: PCT/EP08/56095

§ 371 Date: Nov. 6, 2009

(30) Foreign Application Priority Data
May 30, 2007 (DE) 10 2007 024 967.7

(51) Int. Cl. C08L 83/06; C08L 63/00

(52) U.S. Cl. 525/100; 525/476

(57) ABSTRACT

Thermoset polymer systems are toughened without compromising other polymer properties by including 0.5 to 50 weight percent of 0.001 to 0.4 μm monodisperse core/shell polymers having at least an inner core of a silicone polymer and an outer core of organopolymer.

The invention relates to a reactive resin comprising core-shell particles, and also to a process for its production, and to its use for the production of thermoset plastics with improved mechanical properties, such as fracture toughness and impact resistance.

The crosslinking density of crosslinked reactive resins is mostly very high, and this gives them some valuable properties, making them the most widely used polymers alongside thermoplastics. Among these properties are their hardness, strength, chemicals resistance, and resistance to temperature changes. This makes these reactive resins suitable for applications in a very wide variety of sectors, e.g. for the production of fiber-reinforced plastics, for insulating materials in electrical engineering, and for the production of construction adhesives, high-pressure laminates, stoning lacquers, etc.

The thermosets also have a serious disadvantage, often preventing their use. Because of their highly crosslinked condition, they have very low impact resistance. This is particularly relevant in the low-temperature sector, i.e. at temperatures below 0° C., and the preferred materials for applications where the thermoset could be exposed to high mechanical loads, e.g. impacts, at low temperatures are therefore normally thermoplastic polymers, but disadvantages associated with these have to be accepted, examples being relatively low heat resistance and chemicals resistance.

A number of processes have been developed to improve said performance, by improving the impact resistance or flexibility of thermosets.

Most of said processes are aimed at introducing elastic components as impact modifiers into the reactive resins.

The addition of pulverulent, soft fillers to reactive resins is known, examples being rubber powder or powder composed of flexible plastic. The particle size of these pulverulent additives is in the range from about 0.04 to 1 mm, and this is clearly not adequate to give the desired type of improvement in these reactive resins, and there are moreover attendant disadvantages for other important performance characteristics of thermosets modified in this way.

Addition of plasticizers is used in an attempt to improve the impact resistance of crosslinked reactive resins. This can improve impact resistance, but unfortunately impairs other significant properties of the thermosets. Furthermore, when plasticizers are used there is a latent risk of exudation after the crosslinking of the reactive resin, with the associated adverse consequences for surface properties of the material, for example adhesion, coatability, gloss, etc.

It is also known that liquid or solid, but non-crosslinked butadiene-acrylonitrile rubbers (nitrile rubber, NBR) or else siloxane-polyester copolymers can be used as additives to improve toughness in reactive resins. Said elastomers contain functional groups which can be reacted with the reactive resin during the crosslinking process or else in an upstream reaction. The special feature of said modifiers in comparison with those mentioned hitherto is that although they are miscible with the non-crosslinked reactive resin a phase separation takes place during the crosslinking of the reactive resin, and during this the rubber phase precipitates in the form of fine droplets. Reaction between the reactive resin and the functional groups located at the surface of the nitrile rubber particles produces strong bonding between the rubber phase and the thermoset matrix.

However, thermosets of this type modified with nitrile rubber also unfortunately have significant shortcomings. By way of example, the thermal stability of nitrile-rubber-modified thermosets is impaired, and their usefulness at high temperatures is therefore questionable. The same applies to many electrical properties, e.g. dielectric strength. Because the compatibility of the nitrile rubber with most reactive resins, in particular with epoxy resins, is relatively good a certain proportion of the rubber does not participate in the phase separation during the crosslinking process and becomes incorporated into the resin matrix, and this impairs the property profile of the finished thermoset. A further disadvantage is the very high viscosity of the nitrile-rubber modifiers, which leads to processing problems and impairs the flow properties of the modified reactive resin.

EP 0266513 B1 describes modified reactive resins, and processes for their production, and their use. It is restricted to compositions which comprise, alongside a reactive resin, at most from 2 to 50% by weight of three-dimensionally crosslinked polyorganosiloxane rubbers, having particle sizes of from 0.01 to 50 micrometers in amounts from 2 to 50% by weight, but the properties of the composition described in that document are inadequate in terms of impact strength and impact resistance. Furthermore, the processes described in EP 0266513 B1 have a disadvantage insofar as each reactive resin requires development of different procedures and formulations, and also therefore obtains a different property profile. With the formulations described it is moreover impossible to exclude the presence of unreacted components, e.g. free silicone oils, and the result of this can be impairment of adhesion properties.

WO2006037559 describes modified reactive resins and also processes for their production. Here, solutions of preformed particles in organic solutions are mixed with reactive resins and the reactive resins of the invention can then be obtained via removal of the solvent. Disadvantages of that process are that the amounts of solvents are sometimes large, and in turn require very complicated measures for their removal, and if removal is incomplete the result can be defects in the material during the hardening of the reactive resins. Another disadvantage is the use of inorganic salts which, even after extraction, are still found in the organic solutions of the siloxane particles, since these absorb water to some extent, the result being that traces of water containing salt are always present, and therefore contaminants containing salt, which are undesirable for electronic applications of the reactive resins, are entrained into the reactive resin.

If solid powders are used for the production of the reactive resin mixtures, redispersion of these is incomplete, i.e. their presence within the reactive resin is inhomogeneous.

It is an object of the invention to improve the prior art and to produce a homogeneous reactive resin which, after hardening and shaping, exhibits improved properties in terms of impact strength and impact resistance, and also, if appropriate, exhibits only low conductivity values.

The invention provides a composition comprising

(A) from 50 to 99.5% by weight of a reactive resin or reactive resin mixture which can be processed to give thermosets, and which is liquid at temperatures in the range from 15 to 100° C., having an average molecular weight of from 200 to 500 000, and having a number of suitable reactive groups which is adequate for the curing process, and
(B) from 0.5 to 50% by weight of one or more three-dimensionally crosslinked redispersed polyorganosiloxane rubbers which are present homogeneously in finely dispersed form as polyorganosiloxane-rubber particles with a diameter of from 0.001 to 0.4 μm in the reactive resin or reactive resin mixture, where
the polyorganosiloxane-rubber particles are composed of a core (a) composed of an organosilicon polymer and of an organopolymeric shell (d) and, if appropriate, of two inner shells (b) and (c), where the inner shell (c) is an organic polymer and the inner shell (b) is an organosilicon polymer, composed of
(a) from 20 to 95% by weight, based on the total weight of the polyorganosiloxane-rubber particle, of a core polymer of the general formula (R₃SiO_{1/2})_{w}(R₂SiO_{2/2})ₓ.(RSiO_{3/2})_{y}.(SiO_{4/2})_{z} where w=from 0 to 20 mol %, x=from 80 to 99.5 mol %, y=from 0.5 to 10 mol %, z=from 0 to 10 mol %,
(b) from 0 to 40% by weight, based on the total weight of the polyorganosiloxane-rubber particle, of a polydialkylsiloxane shell composed of units of the formula (R₃SiO_{1/2})_{w}(R₂SiO_{2/2})ₓ.(RSiO_{3/2})_{y}.(SiO_{4/2})_{z} where w=from 0 to 20 mol %, x=from 0 to 99.5 mol %, y=from 0.5 to 100 mol %, z=from 0 to 50 mol %,
(c) from 0 to 40% by weight, based on the total weight of the polyorganosiloxane-rubber particle, of a shell composed of organopolymer of monoolefinically or polyolefinically unsaturated monomers, and
(d) from 5 to 95% by weight, based on the total weight of the polyorganosiloxane-rubber particle, of a shell composed of organopolymer of monoolefinically unsaturated monomers, where R is identical or different monovalent alkyl or alkenyl moieties having from 1 to 6 carbon atoms, aryl moieties, or substituted hydrocarbon moieties.

The moieties R are preferably alkyl moieties, such as the methyl, ethyl, n-propyl, isopropyl, n-butyl, sec-butyl, amyl, or hexyl moiety; alkenyl moieties, such as the vinyl and allyl moiety, and butenyl moiety; aryl moieties, such as the phenyl moiety; or substituted hydrocarbon moieties. Examples of these are halogenated hydrocarbon moieties, such as the chloromethyl, 3-chloropropyl, 3-bromopropyl, 3,3,3-trifluoropropyl, and 5,5,5,4,4,3,3-heptafluoropentyl moiety, and also the chlorophenyl moiety; mercaptoalkyl moieties, such as the 2-mercaptoethyl and 3-mercaptopropyl moiety; cyanoalkyl moieties, such as the 2-cyanoethyl and 3-cyanopropyl moiety; aminoalkyl moieties, such as the 3-aminopropyl moiety; acyloxyalkyl moieties, such as the 3-acryloxypropyl and 3-methacryloxypropyl moiety; hydroxyalkyl moieties, such as the hydroxypropyl moiety.

Particularly preferred moieties are the methyl, ethyl, propyl, phenyl, vinyl, 3-methacryloxypropyl, 1-methacryloxymethyl, 1-acryloxymethyl, and 3-mercaptopropyl moieties, where fewer than 30 mol % of the moieties in the siloxane polymer are vinyl groups, 3-methacryloxypropyl groups, or 3-mercaptopropyl groups.

Preferred monomers used for the organic fraction d) of the polymer are acrylates or methacrylates of aliphatic alcohols having from 1 to 10 carbon atoms, acrylonitrile, styrene, p-methylstyrene, alpha-methylstyrene, vinyl acetate, vinyl propionate, maleimide, vinyl chloride, ethylene, butadiene, isoprene and chloroprene, or difunctional moieties, e.g. allyl methacrylate. It is particularly preferable to use styrene, or else acrylates and methacrylates of aliphatic alcohols having from 1 to 4 carbon atoms, e.g. methyl (meth)acrylate, ethyl (meth)acrylate, glycidyl methacrylate, or butyl (meth)acrylate. Either homopolymers or copolymers of the monomers mentioned are suitable as organic fraction of the polymer.

The average particle size (diameter) of the fine-particle elastomeric graft copolymers is from 10 to 400 nm, preferably from 40 to 300 nm, measured by transmission electron microscopy.

The particle size distribution is preferably very uniform, and the graft copolymers are preferably monomodal, i.e. the particles have one maximum in the particle size distribution and have a polydispersity factor sigma 2 which is at most 0.2, measured by transmission electron microscopy.

It is equally possible to use a mixture of monomodally distributed polyorganosiloxane-rubber particles.

The polyorganosiloxane-rubber particles here can have, at their surface, reactive groups which, prior to or during the further processing of the modified reactive resin, react chemically with the reactive resin, if appropriate in the presence of aids serving as reaction promotors, if appropriate together with small amounts of auxiliaries, in particular of crosslinking agents, catalysts, dispersing agents, and/or curing agents.

Another preferred characteristic of the modified reactive resin is that the content of sodium, magnesium, or calcium ions is below 50 ppm, and also that the content of chloride, and sulfate ions is likewise below 50 ppm.

The content of residual solvent is preferably less than 0.3% by weight, very preferably less than 0.1% by weight.

It is preferable here that the rubber phase located in the core is a silicone rubber or a mixture of a silicone rubber with an organic rubber, e.g. with a diene rubber, fluororubber, or acrylate rubber, or that at least 40% by weight of the core must be composed of a rubber phase. Particular preference is given here to a core composed of at least 50% by weight of a silicone rubber.

Particularly preferred core-shell particles comprise a core composed of at least 20% by weight of a crosslinked silicone core and of a shell composed of at most 60% by weight of a grafted-on organopolymer. Particularly preferred organopolymers are polymers based on poly(alkyl) (meth)acrylates and on copolymers of these with other monomer units.

The glass transition temperature of the shell here is preferably from 60° C. to 150° C., very particularly preferably from 80° to 140° C., determined by means of DSC.

It is preferable that the reactive resin modified in the invention comprises from 1 to 60% by weight, with preference from 1 to 15% by weight, with particular preference from 2 to 5% by weight, of one or more three-dimensionally crosslinked polyorganosiloxane rubbers.

According to the invention, suitable reactive resins are any of the polymeric or oligomeric organic compounds which have a number of suitable reactive groups which is adequate for a curing reaction. Suitable starting products for the production of the reactive resins modified in the invention are generally any of the reactive resins which can be processed to give thermosets, irrespective of the particular crosslinking mechanism by which the particular reactive resin is cured.

In principle, the reactive resins that can be used as starting products can be classified into three groups as a function of the nature of the crosslinking process, via addition, condensation, or polymerization.

From the first group, the reactive resins crosslinked via polyaddition, it is preferable to select one or more epoxy resins, urethane resins, and/or air-drying alkyd resins as starting material. Epoxy resins and urethane resins are generally crosslinked via addition of stoichiometric amounts of a hardener containing hydroxy, amino, carboxy, or carboxylic anhydride groups, and the curing reaction takes place here via addition of the oxirane or isocyanate groups of the resin onto the appropriate groups of the hardener. In the case of epoxy resins, the process known as catalytic curing via polyaddition of the oxirane groups themselves is also possible. Air-drying alkyd resins crosslink via autooxidation with atmospheric oxygen. There are also known addition-curing silicone resins, preferably with the proviso that no further free silanes are present.

Examples of the second group, the reactive resins crosslinked via polycondensation, are condensates of aldehydes, e.g. formaldehyde, with aliphatic or aromatic compounds containing amine groups, e.g. urea or melamine, or with aromatic compounds, such as phenol, resorcinol, cresol, etc., and also furan resins, saturated polyester resins and condensation-curing silicone resins. Curing mostly takes place here via temperature increase with elimination of water, of low-molecular-weight alcohols, or of other low-molecular-weight compounds. The starting material preferably selected for the modified reactive resins of the invention comprises one or more phenolic resins, resorcinol resins and/or cresol resins, and specifically not only resols but also novolaks, and also urea and formaldehyde, and melamine-formaldehyde precondensates, furan resins, and also saturated polyester resins and/or silicone resins.

From the third group, the reactive resins crosslinked via polymerization, preferred starting resins for the modified reactive resins of the invention are one or more homo- or copolymers of acrylic acid and/or methacrylic acid or of esters thereof, and also unsaturated polyester resins, vinyl ester resins, and/or maleimide resins. Said resins have polymerizable double bonds, the polymerization or copolymerization of which brings about three-dimensional crosslinking. Initiators used comprise compounds capable of generating free radicals, examples being peroxides, peroxo compounds, or compounds containing azo groups. Another possibility is initiation of the crosslinking reaction via high-energy radiation, such as UV or electron beams.

The method proposed in the invention can modify not only the abovementioned reactive resins but also any of the other reactive resins suitable for the production of thermoset plastics, and the result after crosslinking and curing is thermosets with considerably improved fracture resistance and impact resistance, while other characteristic properties essential to the thermosets are in essence unaffected, examples being strength, heat resistance, and chemicals resistance. It is of no importance here whether the reactive resins are solid or liquid at room temperature. Nor is the molecular weight of the reactive resins of any practical significance. Compounds often used as hardener components for reactive resins, for example phenolic resins or anhydride hardeners, can also be considered to be reactive resins.

Preferred reactive resins that can be present in the composition of the invention are: epoxy resins, such as bisphenol A diglycidyl ether, bisphenol F diglycidyl ether, novolak-epoxy resins, epoxy resins containing biphenyl units, and aliphatic or cycloaliphatic epoxy resins, such as 3,4-epoxycyclohexylmethyl 3,4-epoxycyclohexanecarboxylate. All of the epoxy resins can deviate to some extent from the monomeric structure, as a function of the degree of condensation during the production process. Acrylate resins can moreover be used for the compositions of the invention. Examples of preferred acrylate resins are triethylene glycol dimethacrylate, urethane dimethacrylate and glycidyl methacrylate. Phenolic resins, urethane resins, and silicone resins can also be used, the latter preferably with the proviso that no further free silanes are present.

The invention also provides a process for the production of reactive resins comprising core-shell particles, characterized in that the following are mixed at temperatures of from 0° C. to 180° C.:

(A) from 50 to 99.5% by weight of a reactive resin or reactive resin mixture which can be processed to give thermosets, and which is liquid at temperatures in the range from 15 to 100° C., having an average molecular weight of from 200 to 500 000, and having a number of suitable reactive groups which is adequate for the curing process, and
(B) from 0.5 to 50% by weight of one or more three-dimensionally crosslinked redispersed polyorganosiloxane rubbers which are present homogeneously in finely dispersed form as polyorganosiloxane-rubber particles with a diameter of from 0.001 to 0.4 μm in the reactive resin or reactive resin mixture, where
the polyorganosiloxane-rubber particles are composed of a core (a) composed of an organosilicon polymer and of an organopolymeric shell (d) and, if appropriate, of two inner shells (b) and (c), where the inner shell (c) is an organic polymer and the inner shell (b) is an organosilicon polymer, composed of
(a) from 20 to 95% by weight, based on the total weight of the polyorganosiloxane-rubber particle, of a core polymer of the general formula (R₃SiO_{1/2})_{w}(R₂SiO_{2/2})ₓ.(RSiO_{3/2})_{y}.(SiO_{4/2})_{z} where w=from 0 to 20 mol %, x=from 80 to 99.5 mol %, y=from 0.5 to 10 mol %, z=from 0 to 10 mol %,
(b) from 0 to 40% by weight, based on the total weight of the polyorganosiloxane-rubber particle, of a polydialkylsiloxane shell composed of units of the formula (R₃SiO_{1/2})_{w}(R₂SiO_{2/2})ₓ.(RSiO_{3/2})_{y}.(SiO_{4/2})_{z} where w=from 0 to 20 mol %, x=from 0 to 99.5 mol %, y=from 0.5 to 100 mol %, z=from 0 to 50 mol %,
(c) from 0 to 40% by weight, based on the total weight of the polyorganosiloxane-rubber particle, of a shell composed of organopolymer of monoolefinically or polyolefinically unsaturated monomers, and
(d) from 5 to 95% by weight, based on the total weight of the polyorganosiloxane-rubber particle, of a shell composed of organopolymer of monoolefinically unsaturated monomers, where R is identical or different monovalent alkyl or alkenyl moieties having from 1 to 6 carbon atoms, aryl moieties, or substituted hydrocarbon moieties, where the polyorganosiloxane-rubber particles (B) are homogeneously dispersed in the reactive resin.

The components are mixed at temperatures of from 0° C. to 180° C., preferably at temperatures of from 10° C. to 80° C., where the polyorganosiloxane-rubber particles are homogeneously dispersed in the reactive resin. Apparatus that can be used here are inter alia stirrers, dissolvers, kneaders, roll mills, high-pressure homogenizers, ultrasound homogenizers and “Ultra-Turrax” dispersion equipment. The temperatures used must be those which do not cause any noticeable crosslinking of the reactive resins during the dispersing stage.

Further solvents can be added here if appropriate, but it is preferable to avoid the use of solvents here.

Further fillers can be added here if appropriate.

The proportion of reactive resin is preferably from 99% by weight to 80% by weight.

This mixture of the invention, composed of reactive resin and polyorganosiloxane-rubber particles, can also, if appropriate, comprise further siloxane particles, e.g. as described in EP 744 432 A or EP 0 266 513 B1.

The modified reactive resins of the present invention have a number of advantages over comparable known products, and can therefore be used advantageously in numerous sectors. Among these advantages are primarily the improvement in fracture resistance and impact resistance of thermoset plastics, and specifically not only at very low temperatures, extending as far as −50° C. as a function of the polyorganosiloxane used, but also at very high temperatures, i.e. up to the softening point of the respective thermoset. Another important point is that the modification does not exert any adverse effect on hardness, strength, and softening point of the crosslinked reactive resin. The elastomer component gives the hardened reactive resin of the invention high resistance to aging, to weathering, to light, and to temperature changes, without any resultant adverse effect on the characteristic properties of the thermoset itself. Nor is there any adverse effect on electrical properties, in particular the insulation properties of the reactive resin, particularly at relatively high temperatures.

The impact-modified reactive resins of the invention can be processed conventionally. The reactive resins modified in the invention are suitable for any of the application sectors in which thermosets are usually used. They are also particularly suitable for applications in which straight thermosets could not hitherto be used because their fracture resistance and impact resistance were unsatisfactory. Particularly suitable uses for the reactive resins modified in the invention are the production of fracture- and impact-resistant, if appropriate shaped, thermoset plastics, fiber-reinforced plastics, insulating materials in electrical engineering, and high-pressure laminates.
Examples relating to redispersibility
Determination of particle size and of polydispersity index sigma 2 with a transmission electron microscope:
A transmission electron microscope and the computer unit attached thereto are used to determine the curves for diameter distribution, surface-area distribution, and volume distribution for each of the specimens. The average value for particle size and its standard deviation sigma can be determined from the curve for diameter distribution. The curve for volume distribution gives the average value required for the average volume V. The curve for surface-area distribution gives the average value required for the average surface area A of the particles. The polydispersity index sigma 2 can be calculated from the following formulae:

sigma 2=sigma/x3/2, where x3/2=V/A
According to P. Becher (Encyclopedia of Emulsion Technology vol. 1, page 71, Marcel Dekker New York 1983) a monomodal particle size distribution is then present when the polydispersity index sigma 2 calculated in accordance with the above-mentioned formula is less than 0.5.
Particle size and polydispersity index were determined using a Phillips (Phillips CM 12) transmission electron microscope and an evaluation unit from Zeiss (Zeiss TGA 10). The latex for measurement was diluted with water and applied to a standard copper mesh by a 1 μl inoculation loop.

It has been found that when a modified reactive resin obtained by the composition proposed in the invention is then subjected to methods known per se for shaping processes and hardening, it gives a thermoset plastic which, when compared with unmodified thermosets or with thermosets not modified in the same way, has considerably improved toughness or fracture resistance, in particular impact resistance, without any, or without any significant, adverse effect on the other properties advantageous for thermosets, examples being resistance to temperature change, strength, and chemicals resistance.

### EXAMPLE 1

### Not of the Invention

### Production of Graft Base:

3800 g of water and 19 g (1.9% by weight, based on Si compounds) of dodecylbenzene sulfonic acid were heated to 85° C. A mixture composed of 855 g (2.9 mol, 74 mol %) of octamethylcyclotetrasiloxane, 97 g (0.7 mol, 18 mol %) of methyltrimethoxysilane, and 66 g (0.3 mol, 8 mol %) of methacryloxypropyltrimethoxysilane was added, and stirring was continued at 85° C. for 4 hours. After removal of about 400 g of distillate the product was a dispersion with 21% by weight solids content and with particle size 111 nm.

### Grafting:

13 050 g of the dispersion were inertized in a 15 l reactor with nitrogen and pH was adjusted to 4.90 g of methyl methacrylate were added, and the polymerization reaction was initiated via addition of 5.2 g (0.6% by weight, based on monomer) of K₂S₂O₈ and 18 g (2.1% by weight, based on monomer) of NaHSO₃ (37% by weight in water). Within a period of 1 hour, a further 780 g of methyl methacrylate were added, and the mixture was then heated to 65° C. and polymerized to completion within a period of 3 hours. This gave a latex with 24% by weight of polymethyl methacrylate in the graft copolymer and with 25.7% by weight solids content, with average particle size 127 nm and polydispersity index sigma 2=0.02.

### EXAMPLE 2

### Of the Invention

### Production of Graft Base:

3000 g of water, 5 g (0.5% by weight, based on Si compounds) of dodecylbenzene sulfonic acid, and 8 g of acetic acid were heated to 90° C. A mixture composed of 855 g (92 mol %) of octamethylcyclotetrasiloxane and 95 g (5 mol %) of vinyltrimethoxysiloxane was added within a period of 2 hours, and stirring was continued for 3 hours.

### Grafting of Shell B:

63 g (2 mol %) of methacryloxypropyltrimethoxysilane were then added, and stirring was continued at 90° C. for 1 hour. This gave a dispersion with 23% by weight solids content and with average particle size 122 nm.

### Grafting of Shell D:

050 g of the dispersion were inertized in a 25 l reactor with nitrogen and pH was adjusted to 4.90 g of methyl methacrylate were added, and the polymerization reaction was initiated via addition of 5.2 g (0.6% by weight, based on monomer) of K₂S₂O₈ and 18 g (2.1% by weight, based on monomer) of NaHSO₃ (37% by weight in water). Within a period of 1 hour, a further 780 g of methyl methacrylate were added, and the mixture was then heated to 65° C. and polymerized to completion within a period of 3 hours. This gave a latex with 23% by weight of polymethyl methacrylate in the graft copolymer and with 27% by weight solids content, with average particle size 137 nm and polydispersity index sigma 2=0.03.

### EXAMPLE 3

### Of the Invention

### Production of Graft Base:

3000 g of water, 5 g (0.5% by weight, based on Si compounds) of dodecylbenzene sulfonic acid, and 8 g of acetic acid were heated to 90° C. A mixture composed of 855 g (92 mol %) of octamethylcyclotetrasiloxane and 95 g (5 mol %) of vinyltrimethoxysiloxane was added within a period of 2 hours, and stirring was continued for 3 hours.

### Grafting of Shell B:

63 g (2 mol %) of methacryloxypropyltrimethoxysilane were then added, and stirring was continued at 90° C. for 1 hour. This gave a dispersion with 23% by weight solids content and with average particle size 132 nm.

### Grafting of Shell D:

050 g of the dispersion were inertized in a 25 l reactor with nitrogen and pH was adjusted to 4.90 g of methyl methacrylate were added, and the polymerization reaction was initiated via addition of 5.2 g (0.6% by weight, based on monomer) of K₂S₂O₈ and 18 g (2.1% by weight, based on monomer) of NaHSO₂ (37% by weight in water). Within a period of 1 hour, a mixture of a further 700 g of methyl methacrylate and 90 g of glycidyl methacrylate was added, and the mixture was then heated to 65° C. and polymerized to completion within a period of 3 hours. This gave a latex with 23% by weight of polymethyl methacrylate in the graft copolymer and with 26% by weight solids content, with average particle size 141 nm and polydispersity index sigma 2=0.03.

### EXAMPLES 4-8

### Isolation of the Core-Shell Materials by Spray Drying

The dispersions produced in examples 1-3 were sprayed from aqueous dispersion. This spraying process used a spray-drying tower from Nubilosa (height 12 m, diameter 2.2 m) with pressure 33 bar to spray the dispersion through a single-fluid nozzle. The inlet temperature was 145° C. and the outlet temperature was 75° C., and the dispersions here had been preheated to 55° C. Throughput was 65 l of dispersion per hour, and the amount of drying air was 2000 m³/h. All three of the dispersions gave pulverulent products.

| | Example | | Example | | Example | |
|---|---|---|---|---|---|---|
| | 4* | | 5 | | 6 | |
| Dispersion used | Example | | Example | | Example | |
| | 1 | | 2 | | 3 | |
| Amount of dispersion | 300 | kg | 300 | kg | 300 | kg |
| Amount of powder | 72 | kg | 48 | kg | 74 | kg |
| Glass transition | −115° | C. | −115° | C. | −115° | C. |
| temperature of core | | | | | | |
| Glass transition | 96° | C. | 110° | C. | 94° | C. |
| temperature of shell | | | | | | |
| Average agglomerate- | 67 | μm | 58 | μm | 43 | μm |
| particle size | | | | | | |

*not of the invention

### Performance Testing

### EXAMPLES 7-18

### Production of Modified Epoxy Resins

The powders obtained in examples 4-6 were incorporated by mixing for about 5 minutes in a rotor-stator mixer (Ultra-Turrax) in varying proportions by weight into various reactive resins, whereupon the temperature rose to about 60-70° C. After addition of the hardener (HT 907, hexahydrophthalic anhydride) and of an accelerator (0.2% by weight of N,N-dimethylbenzylamine) the mixture was again homogenized and degassed, and hardened in aluminum molds at elevated temperatures (1 h 80° C., 3 h 180° C., 1 h 80° C.).

| | Example | Example | Example | Example |
|---|---|---|---|---|
| | 7* | 8 | 9 | 10 |
| Powder used | Example | Example | Example | Example |
| | 4 | 5 | 5 | 5 |
| Reactive resin | Epikote | Epikote | Epikote | Epikote |
| | 828 | 828 | 828 | 828 |
| Reactive resin | Epoxy | Epoxy | Epoxy | Epoxy |
| type | | | | |
| Amount of | 300 g | 300 g | 300 g | 300 g |
| reactive resin A | | | | |
| (epoxy) | | | | |
| Amount of | 213 g | 213 g | 213 g | 213 g |
| reactive resin B | | | | |
| (anhydride) | | | | |
| Amount of | 57 g | 0 g | 13 g | 27 g |
| powder | | | | |
| Theoretical | 10% | 0% | 2.5% | 5% |
| modifier | | | | |
| content (100% | | | | |
| redispersion) | | | | |
| Appearance of | white, | clear | translucent, | translucent, |
| mixture | sediment | | no sediment | no sediment |
| Appearance of | phase- | clear | non- | non- |
| thermoset | separated | | transparent, | transparent, |
| | | | homo- | homo- |
| | | | geneous | geneous |
| Impact resis- | 0.7** | 1.11 | 1.23 | 1.32 |
| tance, 23° C., | | | | |
| (kJ/m²) | | | | |
| Impact resis- | not | 0.93 | 1.02 | 1.10 |
| tance, −20° C., | determin- | | | |
| (kJ/m²) | able*** | | | |

*not of the invention
**values very scattered, very inhomogeneous
***too inhomogeneous and fragile

| | Example | Example | Example | Example |
|---|---|---|---|---|
| | 11 | 12 | 13 | 14 |
| Powder used | Example | Example | Example | Example |
| | 5 | 5 | 5 | 5 |
| Reactive resin | Epikote | Epikote | Araldite | Araldite |
| | 828 | 828 | 179 C | 179 C |
| Reactive resin | Epoxy | Epoxy | Epoxy | Epoxy |
| type | | | | |
| Amount of | 300 g | 300 g | 200 g | 200 g |
| reactive resin A | | | | |
| (epoxy) | | | | |
| Amount of | 213 g | 213 g | 210 g | 210 g |
| reactive resin B | | | | |
| (anhydride) | | | | |
| Amount of | 57 g | 91 g | 46 g | 23 g |
| powder | | | | |
| Theoretical | 10% | 15% | 10% | 5% |
| modifier | | | | |
| content (100% | | | | |
| redispersion) | | | | |
| Appearance of | translucent, | translucent, | translucent, | translucent, |
| mixture | no sediment | no sediment | no sediment | no sediment |
| Appearance of | non- | non- | non- | non- |
| thermoset | transparent, | transparent, | transparent, | transparent, |
| | homo- | homo- | homo- | homo- |
| | geneous | geneous | geneous | geneous |
| Impact resis- | 1.78 | 1.85 | not | not |
| tance, 23° C., | | | determined | determined |
| (kJ/m²) | | | | |
| Impact resis- | 1.31 | 1.75 | not | not |
| tance, −20° C., | | | determined | determined |
| (kJ/m²) | | | | |

The examples show that the redispersible powders provide a simple means of producing curable mixtures of a very wide variety of epoxy resins in a very wide variety of concentrations, with the aim of improving the impact resistance of the epoxy resins thus modified. This cannot be achieved using prior-art powders, because these cannot be incorporated homogeneously.

### EXAMPLE 15

### Production of a Modified Unsaturated Polyester Resin

200 grams of an unsaturated polyester resin (viscosity 650 mPa·s/20° C.), (Palatal P4 01, DSM) were homogenized at 20° C. for 10 minutes with 30 g of powder from example 5 by a mixer using the rotor-stator principle (“Ultra-Turrax”). The temperature rose here to about 45° C., and the product was a whitish, translucent dispersion.

The smooth white dispersion thus obtained, composed of core-shell particles in unsaturated polyester resin, was hardened via addition of 2 ml of MEKP-HA 2 peroxide (Peroxid-Chemie GmbH) and 0.4 ml of Co oct. solution (1% of cobalt in styrene) for 24 h at room temperature and again for 24 h at 80° C.

The glass transition temperature of the homogeneous, hardened resin was 92° C., and impact resistance was 27 kJ/m², while those of the unmodified resin were 93° C. and only 10 kJ/m².

### EXAMPLE 16

200 grams of an epoxy-bisphenol-A-vinyl ester resin (viscosity 450 mPa·s/20° C.), (ALTLAC 430, DSM) were homogenized at 20° C. for 15 minutes with 30 g of powder from example 5 by a mixer using the rotor-stator principle (“Ultra-Turrax”). The temperature rose here to about 55° C., and the product was a whitish, translucent dispersion.

The smooth white dispersion thus obtained, composed of core-shell particles in vinyl ester resin, was hardened via addition of 2 ml of Butanox LPT peroxide (Akzo Nobel) and 1.0 ml of Co oct. solution (1% of cobalt in styrene) for 24 h at room temperature and again for 24 h at 80° C.

The glass transition temperature of the homogeneous, hardened resin was 128° C., and impact resistance was 82 kJ/m², while those of the unmodified resin were 130° C. and only 28 kJ/m².

The silicone core-shell materials of the invention exhibit excellent miscibility with reactive resins, and this leads to greatly improved mechanical properties.

The translucency of the non-crosslinked mixtures shows that the redispersion process breaks the powder agglomerates down to give their primary particles.

The powders not of the invention generally exhibit much poorer redispersibility.

1.-10. (canceled)

11. A composition comprising
(A) from 50 to 99.5% by weight of a reactive resin or reactive resin mixture which can be processed to give thermosets, which is liquid at temperatures in the range from 15 to 100° C., has an average molecular weight of from 200 to 500,000, and which has an amount of reactive groups adequate to cure to a thermoset polymer, and
(B) from 0.5 to 50% by weight of one or more three-dimensionally crosslinked redispersed polyorganosiloxane rubbers which are present homogeneously in finely dispersed form as polyorganosiloxane-rubber particles with a diameter of from 0.001 to 0.4 μm in the reactive resin or reactive resin mixture, where
the polyorganosiloxane-rubber particles are composed of a core (a) composed of an organosilicon polymer and of an organopolymeric shell (d) and, optionally, of two further inner shells (b) and (c), where the inner shell (c) is an organic polymer and the inner shell (b) is an organosilicon polymer, the shells a) through d) comprising
(a) from 20 to 95% by weight, based on the total weight of the polyorganosiloxane-rubber particle, of a core polymer of the formula (R₃SiO_{1/2})_{w}(R₂SiO_{2/2})ₓ.(RSiO_{3/2})_{y}.(SiO_{4/2})_{z} where w=from 0 to 20 mol %, x=from 80 to 99.5 mol %, y=from 0.5 to 10 mol %, and z=from 0 to 10 mol %, where R are identical or different monovalent alkyl or alkenyl radicals having from 1 to 6 carbon atoms, aryl radicals, or substituted hydrocarbon radicals.
(b) from 0 to 40% by weight, based on the total weight of the polyorganosiloxane-rubber particle, of a polydialkylsiloxane shell composed of units of the formula (R₃SiO_{1/2})_{w}(R₂SiO_{2/2})ₓ.(RSiO_{3/2})_{y}.(SiO_{4/2})_{z} where w=from 0 to 20 mol %, x=from 0 to 99.5 mol %, y=from 0.5 to 100 mol %, and z=from 0 to 50 mol %,
(c) from 0 to 40% by weight, based on the total weight of the polyorganosiloxane-rubber particle, of a shell of an organopolymer of monoolefinically or polyolefinically unsaturated monomers, and
(d) from 5 to 95% by weight, based on the total weight of the polyorganosiloxane-rubber particle, of a shell of organopolymer of monoolefinically unsaturated monomers.

12. The composition of claim 11, wherein R is selected from the group consisting of methyl, ethyl, propyl, phenyl, vinyl, 3-methacryloxypropyl, 1-methacryloxymethyl, 1-acryloxymethyl, and 3-mercaptopropyl, where fewer than 30 mol % of the radicals in the siloxane polymer are vinyl groups, 3-methacryloxypropyl groups, or 3-mercaptopropyl groups.

13. The composition of claim 11, wherein the reactive resin or reactive resin mixture is selected from the group consisting of epoxy resins, urethane resins, homo- or copolymers of acrylic acid and/or methacrylic acid or of esters thereof, acrylate resins, phenolic resins, and mixtures thereof.

14. The composition of claim 11, wherein the content of sodium, magnesium, or calcium ions in the reactive resin or reactive resin mixture is smaller than 50 ppm, and the content of chlorine, and sulfate ions is below 50 ppm.

15. The composition of claim 11, wherein the content of residual solvent in the reactive resin or reactive resin mixture is less than 0.3% by weight.

16. The composition of claim 11, wherein the core (a) in the core-shell particle comprises a core composed of at least 20% by weight of a crosslinked silicone.

17. A process for the production of reactive resins comprising core-shell particles of claim 11, comprising mixing the following at temperatures of from 0° C. to 180° C.:
(A) from 50 to 99.5% by weight of a reactive resin or reactive resin mixture which can be processed to give thermosets, which is liquid at temperatures in the range from 15 to 100° C., has an average molecular weight of from 200 to 500,000, and which has an amount of reactive groups adequate to cure to a thermoset polymer, and
(B) from 0.5 to 50% by weight of one or more three-dimensionally crosslinked redispersed polyorganosiloxane rubbers which are present homogeneously in finely dispersed form as polyorganosiloxane-rubber particles with a diameter of from 0.001 to 0.4 μm in the reactive resin or reactive resin mixture, where the polyorganosiloxane-rubber particles are composed of a core (a) composed of an organosilicon polymer and of an organopolymeric shell (d) and, optionally, of two further inner shells (b) and (c), where the inner shell (c) is an organic polymer and the inner shell (b) is an organosilicon polymer, the shells a) through d) comprising
(a) from 20 to 95% by weight, based on the total weight of the polyorganosiloxane-rubber particle, of a core polymer of the formula (R₃SiO_{1/2})_{w}(R₂SiO_{2/2})ₓ.(RSiO_{3/2})_{y}.(SiO_{4/2})_{z} where w=from 0 to 20 mol %, x=from 80 to 99.5 mol %, y=from 0.5 to 10 mol %, and z=from 0 to 10 mol %, where R are identical or different monovalent alkyl or alkenyl radicals having from 1 to 6 carbon atoms, aryl radicals, or substituted hydrocarbon radicals.
(b) from 0 to 40% by weight, based on the total weight of the polyorganosiloxane-rubber particle, of a polydialkylsiloxane shell of units of the formula (R₃SiO_{1/2})_{w}(R₂SiO_{2/2})ₓ.(RSiO_{3/2})_{y}.(SiO_{4/2})_{z} where w=from 0 to 20 mol %, x=from 0 to 99.5 mol %, y=from 0.5 to 100 mol %, and z=from 0 to 50 mol %,
(c) from 0 to 40% by weight, based on the total weight of the polyorganosiloxane-rubber particle, of a shell of an organopolymer of monoolefinically or polyolefinically unsaturated monomers, and
(d) from 5 to 95% by weight, based on the total weight of the polyorganosiloxane-rubber particle, of a shell of organopolymer of monoolefinically unsaturated monomers.

18. A fracture- and impact-resistant, solid thermoset plastic, comprising a cured composition of claim 11.

19. The solid thermoset plastic of claim 18 which is an insulating material.

20. The solid thermoset plastic of claim 18, further comprising reinforcing fibers.
